(19) United States
(12) Patent Application Publication
(10) Pub. No.: US 2026/0268684 A1
(43) Pub. Date: Sep. 10, 2026

(54) OBJECT DETECTION SYSTEM

(71) Applicant: Oshkosh Corporation, Oshkosh, WI (US)

(72) Inventors: Prabhu Shankar, Oshkosh, WI (US); Tim Smullen, Oshkosh, WI (US); Kyle Bush, Oshkosh, WI (US); Mark Hall, Oshkosh, WI (US)

(73) Assignee: Oshkosh Corporation, Oshkosh, WI (US)

(21) Appl. No.: 19/071,465

(22) Filed: Mar. 5, 2025

(51) Int. Cl. G06V 20/58; B60Q 9/00; G06F 3/01; G06V 10/12; G06V 10/82

(52) U.S. Cl. CPC G06V 20/58; B60Q 9/008; G06F 3/016; G06V 20/52; E02F 9/26

(57) ABSTRACT

A work machine includes a first user interface device including a first vibration motor and a second vibration motor and an object detection system comprising a controller communicatively coupled to the first user interface device. The controller is configured to receive a first indication that a first object has been detected on a first side of the work machine, upon receiving the first indication, cause the first vibration motor to activate without causing the second vibration motor to activate, receive a second indication that a second object has been detected on a second side of the work machine, and upon receiving the second indication, cause the second vibration motor to activate without causing the first vibration motor to activate.

### BACKGROUND

The present disclosure relates to lifting devices. More particularly, the present disclosure relates to a battery monitoring system for a lifting device.

### SUMMARY OF THE INVENTION

In some aspects, the techniques described herein relate to a work machine including a first user interface device including a first vibration motor and a second vibration motor; and a controller communicatively coupled to the first user interface device. The controller includes at least one processor and at least one memory storing instructions that, when executed by the at least one processor, cause the at least one processor to perform operations including: receiving a first indication that a first object has been detected on a first side of the work machine; upon receiving the first indication, causing the first vibration motor to activate without causing the second vibration motor to activate; receiving a second indication that a second object has been detected on a second side of the work machine; and upon receiving the second indication, causing the second vibration motor to activate without causing the first vibration motor to activate.

In some aspects, the techniques described herein relate to a vehicle including a base assembly including tractive elements, a lift assembly coupled to the base assembly and configured to lift an implement; a base sensor configured to detect objects proximate the base assembly; a lift sensor configured to detect objects proximate the lift assembly; a first user interface device configured to control the tractive elements to move the vehicle, the first user interface device including a first vibration motor; a second user interface device configured to control the lift assembly to selectively raise and lower the implement, the second user interface device including a second vibration motor; and a controller. The controller is configured to: in response to receiving an indication that the base sensor has detected a first object, cause the first vibration motor to vibrate and not cause the second vibration motor to vibrate; and in response to receiving an indication that the lift sensor has detected a second object, cause the second vibration motor to vibrate and not cause the first vibration motor to vibrate.

In some aspects, the techniques described herein relate to a vehicle including: a joystick including a first side and a second side; a first actuator coupled to the first side of the joystick; a second actuator coupled to the second side of the joystick; and a controller communicatively coupled to the joystick. The controller includes at least one processor and at least one memory storing instruction that, when executed by the at least one processor, cause the at least one processor to perform operations including: upon receiving a signal that the joystick is pivoted toward the first side, causing a component of the vehicle to move toward a first zone; upon receiving a signal that the joystick is pivoted toward the second side, causing a component of the vehicle to move toward a second zone; upon detecting an object in the first zone within a predetermined distance, causing the first actuator to vibrate, the second actuator not caused to vibrate based on objects detected in the first zone; and upon detecting an object in the second zone within a predetermined distance, causing the second actuator to vibrate, the first actuator not caused to vibrate based on objects detected in the second zone.

### BRIEF DESCRIPTION OF THE DRAWINGS

FIG. 1 is a side view of a lift device, according to an example embodiment.

FIG. 2 is a perspective view of the lift device of FIG. 1.

FIG. 3 is a side view of the lift device of FIG. 1.

FIG. 4 is a rear view of an aft end of the lift device of FIG. 1.

FIG. 5 is a top view illustrating a field of view of a camera of the lift device of FIG. 1.

FIG. 6 is a top view illustrating a field of view of a distance sensor of the lift device of FIG. 1.

FIG. 7 is a diagram of a control and alert system for a lift device, according to an example embodiment.

FIG. 8 is a schematic view of sensor distance zones of a lift device, according to an example embodiment.

FIG. 9 is a perspective view of a user interface panel of a lift device, according to an example embodiment.

FIG. 10 is a size view of a joystick according to an example embodiment.

FIG. 11 is a top view of the joystick of FIG. 10.

FIGS. 12 and 13 are perspective views of a joystick according to an example embodiment.

FIGS. 14 and 15 are perspective views of a joystick according to an example embodiment.

FIG. 16 is a perspective view of a lift device, according to an example embodiment.

FIG. 17 is a perspective view of a boom lift with nine sensor zones, according to an example embodiment.

FIG. 18 is a top view of the lift device of FIG. 17.

FIG. 19 is a side view of the lift device of FIG. 17.

FIG. 20 is a perspective view a user interface panel mounted to a lift device, according to an example embodiment.

FIG. 21 is a graphical user interface illustrating a scissor lift with six sensor zones, according to an example embodiment.

FIG. 22 is a graphical user interface illustrating a telehandler with four sensor zones, according to an example embodiment.

FIG. 23 is a perspective view of an indicator on a left side mirror of a lift device, according to an example embodiment.

FIG. 24 is a perspective view of an indicator on a right side mirror of a lift device, according to an example embodiment.

FIG. 25 is a perspective view of an indicator on an A-pillar of a lift device, according to an example embodiment.

FIG. 26 is a perspective view of an indicator on a B-pillar of a lift device, according to an example embodiment.

FIGS. 27-49 show graphical user interfaces with indicators according to example embodiments.

FIG. 50 is a diagram of a method for controlling a user interface device of a lift device, according to an example embodiment.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

Following below are more detailed descriptions of various concepts related to, and implementations of, methods and systems for detecting objects proximate a work machine and providing information and alerts to an operator of the work machine regarding the detected objects. The various concepts introduced above and discussed in greater detail below may be implemented in any of a number of ways, as the described concepts are not limited to any particular manner of implementation. Examples of specific implementations and applications are provided primarily for illustrative purposes.

Referring to the figures generally, various embodiments disclosed herein relate to detecting objects near a work machine or lift device and providing information and alerts to an operator of the work machine or lift device. Objects may be detected using sensors and cameras. For example, a distance sensor may be used to detect and determine a distance of an object from the work machine or lift device. Image data, such as a video feed, may be processed using, for example, an object detection and classification system to determine whether detected objects are animate (e.g., human) or inanimate. Various methods and devices may be used to alert the driver of the detected object. For example, a haptic feedback system may cause a user interface device to vibrate. In another example, a graphical user interface may display sensor zones that may be illuminated or colored-in when an object is detected. In another example, dedicated indicators may be positioned around an operator area of the work machine or lift device and may be illuminated when an object is detected. The alert or indication may vary based on the determined distance to the object and/or whether the object is animate. For example, vibration intensity or frequency may vary based on the distance to the object. Visual indicators may vary in color or may flash or pulsate based on the distance to the object. Further, different alerts may be generated based on the location of the detected object. For example, a first user interface device (e.g., a first joystick, a first lever, a first steering wheel, etc.) may be caused to vibrate when an object is detected in a first region adjacent the work machine or lift device, and a second user interface device (e.g., a second joystick, a second lever, a second steering wheel, etc.) may be caused to vibrate when an object is detected in a first second adjacent the work machine or lift device. In some examples, a first portion of a user interface (e.g., a left side of a joystick) may be caused to vibrate when an object is detected on a first side (e.g., the left side) of the work machine or lift device, and a second portion of a user interface (e.g., a right side of a joystick) may be caused to vibrate when an object is detected on a second side (e.g., the right side) of the work machine or lift device. In some embodiments, audible alerts (e.g., alarms, warnings, etc.) may be generated instead of or in addition to visual or haptic alerts. These systems and methods may bring detected objects to the attention of the operator that the operator may not notice or be able to see.

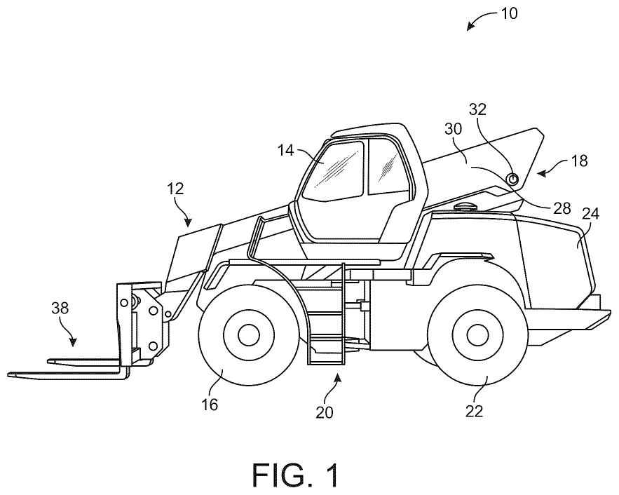

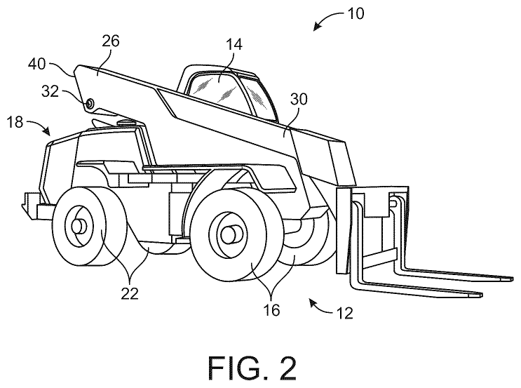

With reference to FIGS. 1-3, a lift device, shown as telehandler 10 includes a forward frame 12 supporting an operator cab 14. The forward frame 12 is provided with a set of tractive elements, shown as front wheels 16, for supporting the forward frame 12. An aft frame 18 is coupled with the forward frame 12 at a coupling point 20. The aft frame 18 is provided with a set of tractive elements, shown as rear wheels 22, for supporting the aft frame 18. In some embodiments, the coupling point 20 is a frame pivot such that the forward frame 12 is pivotable relative to the aft frame 18 via the frame pivot. In some embodiments, the telehandler 10 may include a single frame extending from the aft end 19 to the forward end 13 of the telehandler 10, rather than forward frame 12 and the aft frame 18 being coupled together at a frame pivot.

References to forward and aft directions as well as front and rear wheels are relative to a forward driving direction of the telehandler 10. A drive system including an engine and transmission drives one or both sets of wheels 16, 22. The drive system also includes control implements for positioning the boom/load and for steering. An operator may steer the vehicle by manipulating a user input device, such as a steering wheel or steering handle/joystick located in the cab 14. In some embodiments, the operator cab is equipped with both a steering wheel and a steering handle to command speed and direction of travel with an operator selector switch. In the illustrated embodiment, driving components including the engine and transmission drive and the like are housed within an engine casing 24 that forms part of the aft frame 18.

A cantilever support 26 is secured at a fixing point to the forward frame 12. The cantilever support 26 extends from the fixing point aft beyond the coupling point 20 to a boom support 28 adjacent a distal end. As shown, in some embodiments, the cantilever support 26 is oriented at an angle from a low position at the fixing point to a high position at the distal end.

Additionally, in some embodiments, the boom support 28 is vertically spaced from the aft frame 18. A boom 30 is pivotably secured to the boom support 28 at a boom pivot 32. The boom pivot 32 is aft of the coupling point/frame pivot 20 and may be aft of an axle 34 of the rear wheels 22. In this context, the distal end of the cantilever support 26 may thus similarly be positioned aft of the rear wheel axle 34 as shown. In the embodiment shown, the forward frame 12 forms part of a forward section of the machine, which may include the forward frame 12, operator cab 14, front axle 35 and cantilever support 26. The aft frame 18 forms part of a rear section of the machine, which may include the aft frame 18, the engine (not shown), engine casing 24, engine hood, etc.

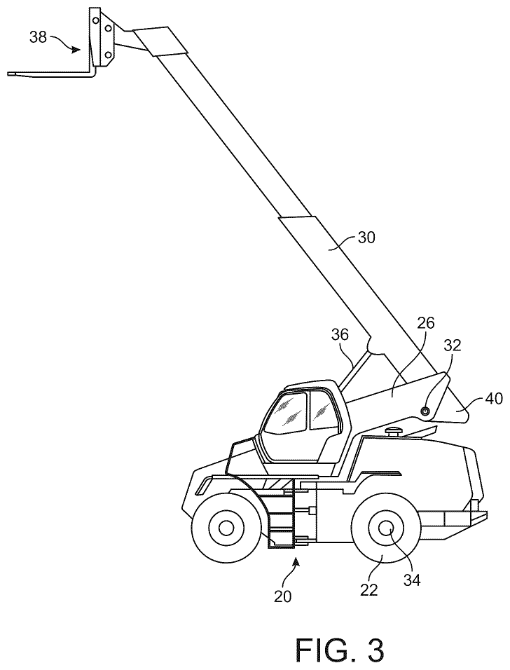

The boom 30 may be a telescoping boom that is extendable and retractable by a suitable actuator. A lifting actuator 36 is connected between the cantilever support 26 and/or the forward frame 12 and the boom 30. Extension of the lifting actuator 36 raises the boom 30 by pivoting the boom 30 on the boom pivot 32. A work implement 38 such as the fork carriage shown in the drawings is attached at a distal end of the boom 30. The manner of connecting the work implement 38 and controlling the work implement 38 during use are known and will not be further described. In some embodiments, as shown in the drawings, the boom 30 includes an angled end 40 adjacent the boom pivot 32. As shown in FIG. 3, the angled end 40 serves to provide the boom 30 with an effective length that is beyond the boom pivot point 32. The angled end 40 enables the boom 30 to be raised without impacting the components mounted under the boom 30 or cantilever support 26.

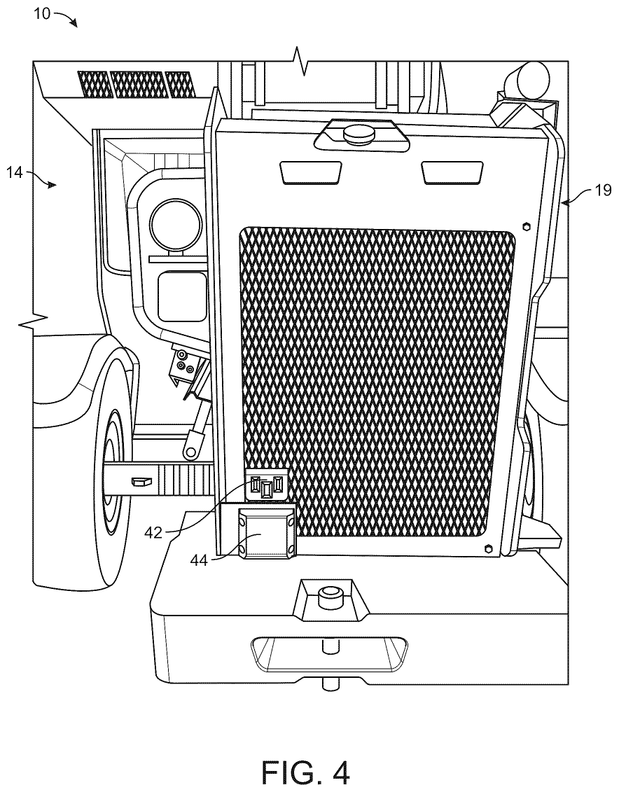

Referring now to FIG. 4, the aft end 19 of a telehandler 10 is shown, according to an example embodiment. In the embodiment shown, the telehandler includes a camera 42 and a distance sensor 44, shown as a RADAR. In some embodiments, the camera 42 may be a visible spectrum camera (e.g., an RGB camera). In other embodiments, the camera 42 may be an infrared (e.g., short-wave infrared) camera or a thermal imaging camera. In some embodiments, the distance sensor 44 may be a LiDAR or an ultrasonic sensor. In some embodiments, the telehandler may include more than one camera 42 and/or more than one distance sensor 44. As shown in FIG. 4, the camera 42 and distance sensor 44 are positioned on the aft end 19, for example, a rear-facing (or aft-facing) structure of the telehandler. The camera 42 and the distance sensor 44 may be arranged facing rearward, in a direction opposite the forward direction of the telehandler. For example, various user input devices (e.g., a steering wheel, a joystick, switches, levers, etc.) may be arranged in the operator cab 14 to be used by an operator facing a first, forward direction. The camera 42 and distance sensor 44 may be arranged facing in a second, rearward direction opposite the first direction. Thus, the camera 42 may be arranged to capture image data of objects behind the telehandler 10, and the distance sensor 44 may be configured capture distance data indicating distances to objects behind the telehandler 10. In some embodiments, the camera 42 may also capture distance information similar to distance sensor 44.

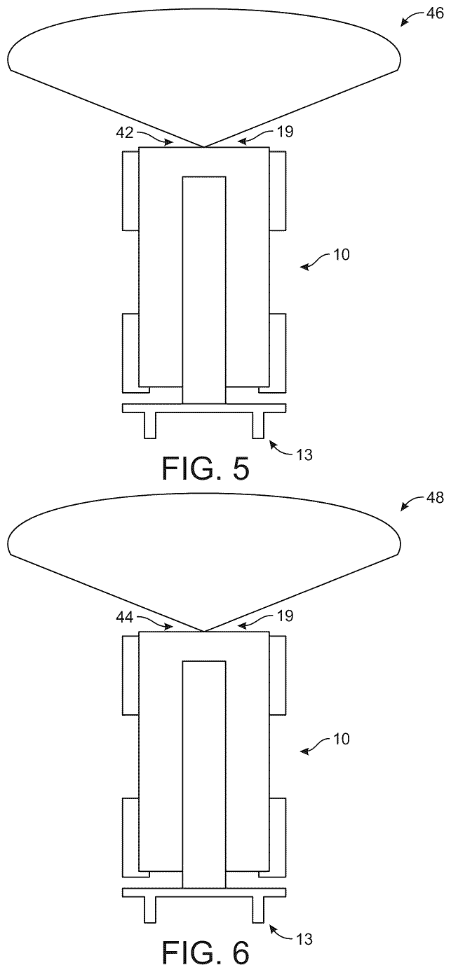

FIGS. 5 and 6 respectively show a field of view 46 of the camera 42 and a field of view 48 of the distance sensor 44. As shown in FIGS. 5 and 6, the field of view 46 of the camera 42 and the field of view 48 of the distance sensor 44 are the same. Specifically, as shown, both fields of view 46, 48 are 150 degrees wide and centered along a line perpendicular to the rear-facing structure of the telehandler 10 (i.e., directly rearward). The camera 42 may be positioned immediately above or immediately below the first sensor 44 or immediately next to the first sensor 44 so that the field of view may be substantially the same. In other embodiments, the fields of view 46, 48 may be substantially similar and/or may substantially overlap. Because the fields of view 46, 48 overlap and or are the same or substantially the same, objects (e.g., pedestrians, animals, inanimate objects, etc.) can be detected by both the camera 42 and the distance sensor 44 simultaneously, and a distance may be correlated with an object detected by the camera 42.

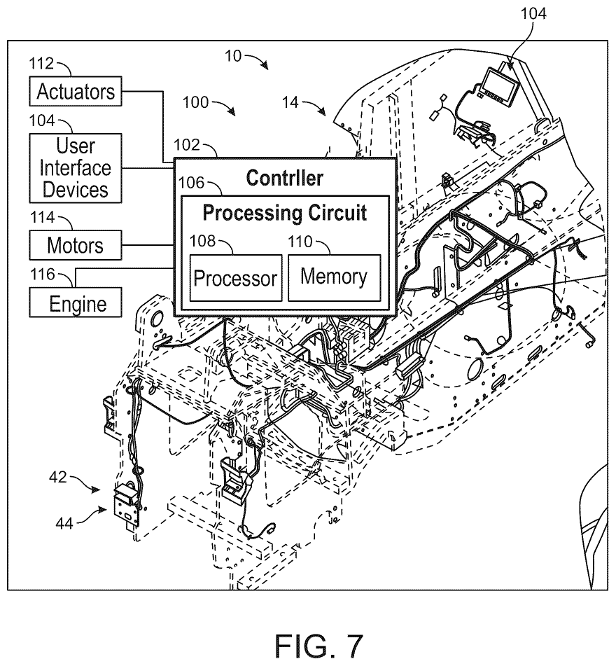

Referring now to FIG. 7, a control and alert system 100 for the telehandler 10 is shown according to an example embodiment. The control and alert system 100 includes an object detection system including the camera 42 and the distance sensor 44 as well as a controller 102 and a user interface device 104, shown as a display screen in the operator cabin 14. The controller 102 may be communicatively coupled to the camera 42, the distance sensor 44, and the user interface device 104. The controller 102 includes at least one processing circuit 106 including at least one processor 108 and at least one memory 110. The at least one processing circuit 106 can be communicably connected to a communications interface such that the at least one processing circuit 106 and the various components thereof can send and receive data via the communications interface. The at least one processor 108 can be implemented as a general purpose processor, an application specific integrated circuit (ASIC), one or more field programmable gate arrays (FPGAs), a group of processing components, or other suitable electronic processing components. The controller 102 may be or may be a component of a vehicle control unit configured to control operation of the telehandler 10. The controller 102 may be further communicatively coupled to and configured to control various actuators 112, for example, actuators to lift the boom 30, actuators to turn the wheels 16, 22, etc. The controller 102 may be further communicatively coupled to and configured to control one or more engines 114 or motors 116 configured to drive the telehandler 10 by turning the wheels 16, 22. The controller 102 may be further communicatively coupled to and configured to receive operator inputs from additional user interface devices 104, for example, a steering wheel, joysticks, switches, pedals, levers, etc. The controller 102 may control the actuators 112, engine 114, and/or motors 116 based on user inputs via the user interface devices 104.

For example, the vehicle control unit may receive commands from various user interface devices and may control various actuators, motors, engines, etc. to control the movement of the telehandler 10, including the wheels 16, 22 and the boom 30.

The at least one memory 110 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The at least one memory 110 can be or include volatile memory or non-volatile memory. The at least one memory 110 can include database components, object code components, script components, or any other type of information structure for supporting the various activities and information structures described in the present application. According to some embodiments, the at least one memory 110 is communicably connected to the at least one processor 108 via the at least one processing circuit 106 and includes computer code (e.g., instructions) for executing (e.g., by the at least one processing circuit 106 and/or the at least one processor 108) one or more processes described herein.

As discussed above, the controller 102 may be communicatively coupled to the camera 42, the distance sensor 44, and the user interface device 104. In some embodiments, the camera 42 may include a neural processing unit configured to use image processing techniques, deep neural processing, tensor processing, machine learning, etc. to detect pedestrians and other objects. The neural processing unit of the camera 42 may also use these techniques to estimate the distance of the pedestrian or other object from the lift device or work machine. The controller 102 may receive information from the neural processing unit including the estimated distance to the object and whether the object is a pedestrian. The controller 102 may also receive an estimated distance to the object from the distance sensor 44. The controller 102 may compare the two estimated distances and, if the object is a pedestrian as determined by the camera 42, use the closer distance to provide information (e.g., alarms, warning signals, etc.) to a user via the user interface device 104.

In some embodiments, the controller 102 may be configured to receive image data from the camera 42 and distance data from the distance sensor 44 and to provide information (e.g., alarms, warning signals, etc.) to a user via the user interface device 104. For example, the controller 102 may receive an indication (e.g., a sensor signal, sensor data, etc.) from the distance sensor 44 that an object has been detected. The controller 102 may also receive image data from the camera 42 and may determine, based on image processing techniques that a human (e.g., a pedestrian) or other animate object is present in the field of view 46 of the camera 42.

Thus, the controller 102 may be configured to perform functions similar to those of the neural processing unit of the camera 42 described above. Using the distance data from the distance sensor 44, the controller 102 may determine the distance from the distance sensor 44 to the detected pedestrian. Based on detecting the pedestrian and determining the distance to the pedestrian, the controller 102 may, for example, cause the user interface device 104 to display an alert or warning to the operator of the telehandler indicating the proximity of the pedestrian, for example, by generating a graphical user interface including the alert and causing the user interface to display the graphical user interface. In other examples, the controller 102 may cause an audible alert to be generated in the cabin of the telehandler 10 or may cause other user interface devices 102 (e.g., joysticks, levers, switches, etc.) to vibrate.

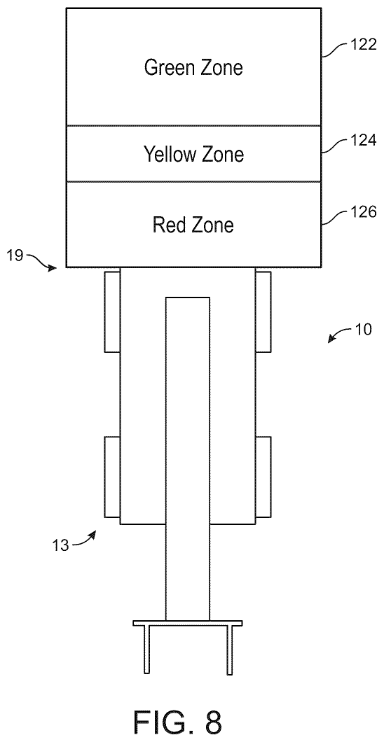

In some embodiments, the alert may be color coded based on the determined distance. For example, FIG. 8 shows zones (regions, areas, etc.) located behind the telehandler corresponding to a level of alert. For example, if a pedestrian is detected in the green zone 122 more than seven feet from the distance sensor 44, the controller 102 may cause the user interface device 104 to display a green alert; if a pedestrian is detected in the yellow zone 124 between five and seven feet from the distance sensor 44, the controller 102 may cause the user interface device 104 to display a yellow alert; and if the pedestrian is detected in the red zone 126 less than five feet from the distance sensor 44, the controller 102 may cause the user interface device 104 to display a red alert. While the zones 122, 124, 126 are shown as rectangular and planar, it should be understood that the zones may be three dimensional and differently shaped (e.g., circular, conical). Further, the distances defining the bounds of the zones 122, 124, 126 may be different. For example, the distances may be customizable based on the application, the type of lift device or work machine, or the needs of the customer. In some embodiments, a graphical representation of the zones 122, 124, 126 may be displayed to an operator of the telehandler 10 (e.g., via a GUI on a display screen, as described below) along with a graphical representation of the telehandler 10. For example, an image of FIG. 8 may be displayed on the GUI. Detected objects may also be indicated on the GUI, for example, with a symbol or icon positioned within the graphical representation of the zone 122, 124, 126 in which the object is detected. In some embodiments, the position of a steering wheel may cause guide lines to be overlaid on the GUI in the direction of travel (e.g., a trajectory) of the telehandler 10 (e.g., over a bird's-eye view of a graphical representation of the telehandler 10), such that the operator may be alerted as to whether the object is in the expected path of the telehandler 10. The bird's-eye view of the graphical representation of the telehandler 10 may be adjusted based on the current state of the telehandler to indicate the current footprint of the telehandler and the trajectory of the extremities of the footprint. For example, if the boom 30 is fully extended, the sweep of the work implement 38 as the telehandler 10 turns may be larger than if the boom 30 is retracted. This may be indicated on the GUI and the zones 122, 124, 126 may be adjusted accordingly.

It should be understood that the alert may not be limited to providing a graphical user interface to a display screen. For example, the alert may be indicated by one or more dedicated lights or light-up symbols positioned throughout the telehandler 10, may be indicated via a dead front icon panel in which an alert symbol is only visible when a light is illuminated, may be indicated with audible sounds or words (e.g., generated by a speaker), or may be indicated via a haptic feedback system integrated into the user control system. In some embodiments, an audible alert may be provided external to the operator cab 14 so that a detected pedestrian is alerted to the presence of the telehandler in operation. These embodiments are described in further detail below.

While the embodiments described above relate to the detection of objects rearward of a telehandler 10, it should be understood that similar techniques may be used to detect objects in the proximity of any type of lift vehicle (e.g., boom lifts, scissor lifts, etc.) in any direction (e.g., forward of the lift vehicle, above the lift vehicle, on either side of the lift vehicle, on the ground proximate the lift vehicle, at an elevated location proximate the lift vehicle, etc.). Further, in some examples, objects may be detected and their distances from the lift device determined using distance data from one or more distance sensors 44 without also using image data from a camera 42, and in some examples, objects may be detected using image data (e.g., using image processing techniques) from one or more cameras 42 without also using distance data from a distance sensor 44, though these detection methods may be less accurate than object detection methods using both image data and distance data.

### Haptic Feedback System

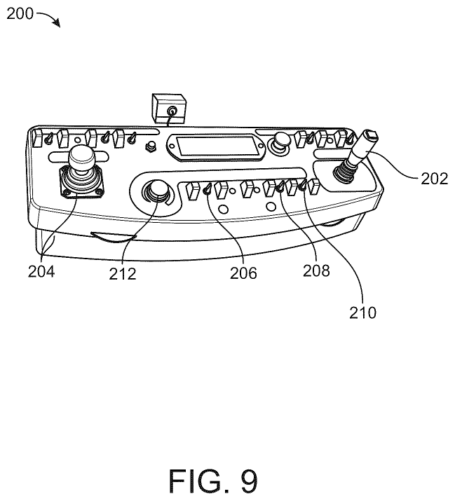

Referring now to FIG. 9, a user interface panel 200 is shown according to an example embodiment. The user interface panel 200 may be positioned, for example, within the operator cab 14 of the telehandler 10 or may be part of another lift device (e.g., a boom lift, a scissor lift, etc.). The user interface panel 200 may be communicatively connected to a vehicle controller (e.g., a vehicle control unit) of the lift device, such that inputs from a user to the user interface panel 200 may control the motion of the telehandler 10. The user interface panel 200 may have several user interface devices 104 used to control the motion of the telehandler 10. For example, in the embodiment shown, the user interface panel 200 includes a first joystick 202 for controlling the wheels 16, 22 to drive the telehandler 10 forward and backward and steer the telehandler 10. The user interface panel 200 includes a second joystick 204 for raising, lowering, and rotating the boom 30. The user interface panel 200 includes several switches 206, 208, 210 for controlling various aspects of the boom 30, such as telescope extension and the angles of specific sections of the boom 30. The user interface panel 200 includes a speed dial 212 for controlling the sensitivity and maximum speed of the motions controlled by the various other user interface devices 104. The user interface panel 200 includes an emergency stop that, when pressed, causes all motions of the telehandler 10 to stop. The user interface panel 200 may include several other switches, dials, and buttons for controlling other aspects of the telehandler 10.

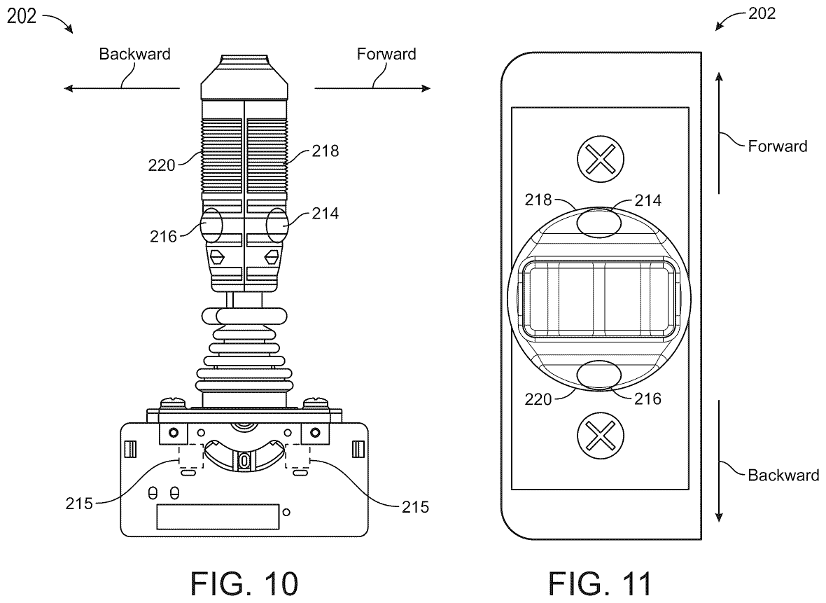

The user interface panel 200 may be communicatively connected to the controller 102. Its other embodiments, the controller 102 may be a component of the vehicle control unit. As discussed above, the controller 102 may be configured to receive image data (e.g., a video feed) from the camera 42 and distance data from the distance sensor 44 and to provide information (e.g., alerts) to a user via a user interface device 104 based on the image and distance data. In some embodiments, the information provided to the user may be provided via haptic feedback via the user interface devices 104 of the user interface panel 200 (e.g., the joysticks 202, 204 and switches 206, 208, 210). For example, in FIGS. 10 and 11, the first joystick 202 is shown, according to an example embodiment, including two actuators, shown as vibration motors 214, 216, embedded therein for providing haptic feedback to a user. The vibration motors 214, 216 may be fixed to, inside, or on the surface of the first joystick 202. Upon, in response to, or based on receiving an indication that an object has been detected in a sensor zone, the controller 102 may cause a vibration motor to activate (e.g., to vibrate).

FIG. 10 shows a side view of the first joystick 202, and FIG. 11 shows a top view of the first joystick 202. The vibration motors 214, 216 are positioned respectively on a forward side 218 and a rearward side 220 of the first joystick 202. Pushing forward (i.e., toward the forward side 218) on the first joystick 202 (e.g., deflecting the first joystick 202 forward) may send a signal to the vehicle controller indicating a request to drive the lift vehicle forward. Upon receipt of the signal, the vehicle controller may cause the wheels 16, 22 to rotate in a first direction to drive the telehandler 10 forward. Pushing or pulling rearward (i.e., toward the rearward side 220) on the first joystick 202 (e.g., deflecting the first joystick 202 rearward) may send a signal to the vehicle controller indicating a request to drive the lift vehicle backward. Upon receipt of the signal, the vehicle controller may cause the wheels 16, 22 to rotate in the opposite direction to move the telehandler 10 backward. The vibration motors 214, 216 may be communicatively coupled to the controller 102 such that, when an object is detected proximate the telehandler 10, the controller 102 may provide information (e.g., alerts) to the user by activating at least one of the vibration motors 214, 216 to vibrate. The vibration motors 214, 216 may be eccentric rotation mass motors that cause vibration by spinning an unbalanced mass on a shaft or may be linear resonant actuators that repeatedly drive a mass against a spring force to create vibration.

In other embodiments, the actuators causing the vibration may be piezoelectric actuators, electromagnetic actuators, or another type of device capable of generating vibrations. Activating the vibration motors 214, 216, may cause the first joystick 202 to vibrate, which may be felt by the operator holding the first joystick 202.

In some embodiments, the controller 102 may activate one of the vibration motors 214, 216 based on the location of the object detected. For example, if an object is detected on a first side (e.g., in front) of the telehandler 10, the vibration motor 214 on the forward side 218 of the first joystick 202 may be activated while the vibration motor 216 on the rearward side 220 of the first joystick 202 is not activated. If an object is detected on a second side (e.g., behind) the telehandler 10, the vibration motor 216 on the rearward side of the first joystick 202 may be activated while the vibration motor 214 on the forward side 218 of the first joystick 202 may not be activated. Thus, in addition to providing an alert to the user that an object has been detected proximate the telehandler or 10 the controller 102 also identifies the location of the object (e.g., in front of or behind the telehandler 10). In some embodiments, the first joystick 202 may include additional vibration motors, for example, on the left and right sides of the first joystick 202, which may be activated, for example, when an object is detected on the left or right side of the telehandler 10, respectively. Stated more generally, where moving a joystick 202, 204 or other user interface device 104 causes a component of the telehandler 10 or other work machine or vehicle to move toward a specific sensor zone, a vibration motor associated with that sensor zone may be caused to vibrate when an object is detected in that sensor zone. The vibration motor associated with a specific sensor zone may be positioned on a side of the user interface device 104 corresponding to a direction to the sensor zone from the telehandler 10 or other machine or vehicle.

As discussed above, alerts provided to the user may be adjusted based on the distance of the object to the telehandler 10. For example, a first level of alert may be provided when an object is detected in the green zone 122 as shown in FIG. 8, a second level of alert may be provided when an object is detected in the yellow zone 124, and a third level of alert may be provided when an object is detected in the red zone 126. When the alert is provided by haptic feedback (e.g., by vibration of the vibration motors 214, 216), a vibration or activation pattern may be defined or adjusted for each level of alert. For example, when an object is detected in the green zone 122 behind the telehandler 10, the vibration motor 216 may be periodically activated to generate two vibration pulses per second; when an object is detected in the yellow zone 124 behind the telehandler 10, the vibration motor 216 may be periodically activated to generate four vibration pulses per second; and when an object is detected in the red zone 126 behind the telehandler 10, the vibration motor 216 may be periodically activated to generate eight vibration pulses per second. In some embodiments, the rate of pulses may continuously vary based on the distance to the object (e.g., without predefined distance zones). The lines delineating the zones 122, 124, 126 may define threshold distances that controller 102 may compare to the distance to a detected object. The vibration intensity or pulse frequency may be lower when the distance to the detected object is greater or larger than the threshold distance, and the vibration intensity or pulse frequency may be higher when the distance to the detected object is less than or smaller than the threshold distance.

In some embodiments, the vibration pattern may be defined or adjusted based on the type of object detected. For example, if the controller 102 determines that the object is a stationary inanimate object, the vibration motors 214, 216 may be periodically activated as discussed above, and if the controller 102 determines that the object is a pedestrian, the vibration motors 214, 216 may be activated constantly while the pedestrian is detected. These examples are not meant to be limiting. Any patterns of pulses or changes may be used to convey information to the operator. Further, the intensity of the vibration may also vary (e.g., by adjusting the speed of the vibration motor 214, 216) to convey different information to the operator. For example, the vibration intensity may increase proportionally with the proximity of the object to the distance sensor 44 (e.g., as the object gets closer to the telehandler 10, the vibration intensity increases). Intensity or frequency of vibration pulses may correspond with more urgent alerts (e.g., a pedestrian in the red zone 126). Adjusting the vibration pattern may also include adjusting the intensity of the vibration. For example, when the controller 102 detects a closer objects or objects determined to be a pedestrian or otherwise animate objects, the intensity of the vibrations may be increased.

As discussed above, the incorporation of vibration motors is not limited to the first joystick 202 but may be applied to any user interface device 104. For example, similar vibration motors may be positioned in any other user interface devices (e.g., switches, knobs, buttons, steering wheels, pedals including accelerator and brake pedals, touchscreen displays, etc.) or in other accessories or devices within the operator cab 14 (e.g., the driver's seat, a safety helmet, a safety harness, gloves, wearable smart devices such as smart watches and smart rings, etc.). The controller 102 may send a signal to the accessory or other device instructing and causing the vibration motor in the accessory or other device to vibrate, for example, at the same time and in the same pattern as the vibration motor I the user interface device 104). In some embodiments, the activated vibration motor may correspond to the user interface device 104 that can be controlled to avoid the object. For example, the vibration motors 214, 216 in the first joystick 202 may be activated if an object is detected near the forward frame 12 or the aft frame 18. However, if an object is detected proximate to the boom 30, vibration motors in the second joystick 204, which is used to control the extension and rotation of the boom 30, may be activated. If, for example, more than one user interface device 104 may cause the telehandler 10 to move towards the detected object, vibration motors in each of those user interface devices 104 may begin to vibrate. Thus, regardless of the user interface device 104 that the operator is currently using, if the user interface device 104 is capable of moving the telehandler 10 towards the detected object, the operator may receive the alert though the haptic vibrations. The vibration pattern of each vibration motor may be the same (e.g., identical) when vibration motors in more than one user interface device 104 are activated based on the same detected object. In some examples, the vibration caused by the vibration motors may be audible. Thus, if the controller 102 determines that a collision with the object is likely if action is not taken, vibration motors of a user interface device 104 that can be used to actively avoid the collision may activate, and the sound of the vibration may alert the operator, who may then engage the user interface device 104 to attempt to avoid the collision.

In some embodiments, the patterns used in each user interface device 104 may correspond to the same message or alert. For example, steady vibration that increases in intensity based on proximity may be used to indicate a detected pedestrian in each of the joysticks 202, 204, switches 206, 208, 210, and any other user interface device 104. Providing consistent haptic signals across various user interface devices 104 may help to ensure that the operator remembers what the signals mean when felt so that the operator can react appropriately.

In some embodiments, the user interface devices 104 may include motors configured to restrain the motion of the user interface device 104. Using the first joystick 202 as an example, additional motors (e.g., restrainer motors 215) may be incorporated to restrain the motion (e.g., the deflection) of the first joystick 202 forward and backward. For example, pivoting the first joystick 202 forward may send an indication to the controller 102 to cause the telehandler 10 to move forward (e.g., by turning the wheels 16, 22), and pivoting the first joystick 202 backward may send an indication to the controller 102 to cause the telehandler 10 to move backward. If an object is detected behind the telehandler 10, a motor may resist the movement of the first joystick 202 in the rearward direction, and if an object is detected in front of the telehandler 10, a motor, may resist the movement of the first joystick 202 in the forward direction. Thus, based on the increased resistance in the first joystick 202 (e.g., the additional force required to deflect the first joystick 202), a message may be conveyed to the operator that an object is present.

In some embodiments, instead of or in addition to the restrainer motors 215, the controller 102 may restrict the speed of the wheels 16, 22 when an object is detected. For example, the maximum speed of the wheels when an object is detected may be half that (or some other percentage) of the maximum speed of the wheels when no object is detected. In some embodiments, the controller 102 may cause the brakes to be applied or prevent movement of the wheels 16, 22 or the boom 30 if an object is detected within a specified distance in order to actively avoid a collision. The speed of the telehandler 10 or the speed of the motion of the boom 30 may also be taken into account in determining whether a collision is likely unless the motion is stopped. In some embodiments, all of these features may be applied depending on distance to the object and/or speed of the wheels 16, 22 or the boom 30. For example, haptic, visual, or audible alerts may be generated when an object is detected relatively far from the telehandler 10 (e.g., in the green zone 122); movements of the telehandler 10 may be restricted when an object is detected an intermediate distance from the telehandler 10 (e.g., in the yellow zone 124); and movement of the telehandler 10 may be stopped when an object is detected relatively close to the telehandler 10 (e.g., in the red zone 126).

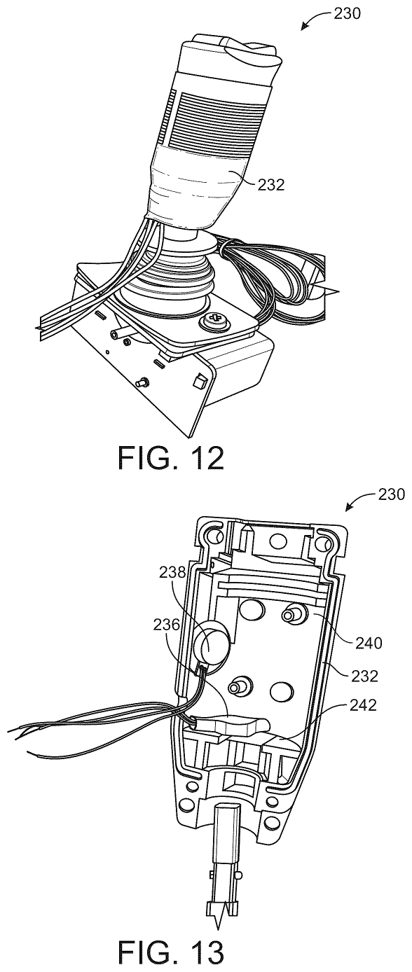

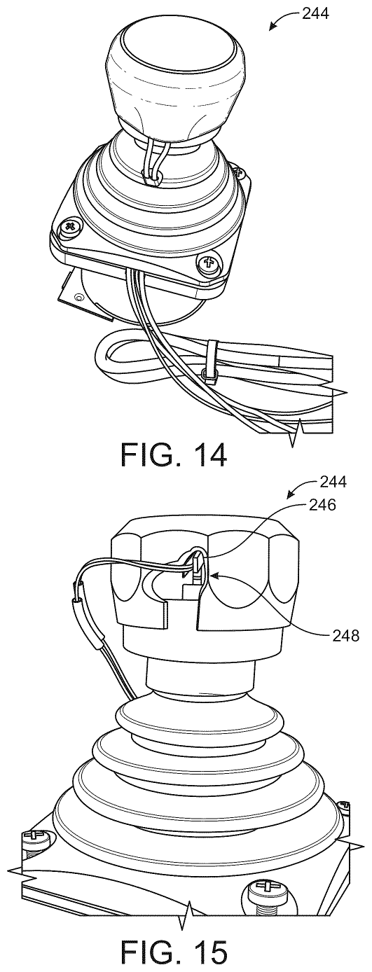

FIGS. 12 and 13 illustrate a prototype of a joystick 230 according to an example embodiment. The joystick 230 may be a steering joystick, similar to the first joystick 202. As shown in FIG. 13, the joystick 230 includes a hollow handle 232 with an inner cavity 234. Two vibration motors 236, 238 (e.g., similar to the vibration motors 214, 216) are respectively coupled to an inner side wall 240 and an inner lower wall 242. The vibration intensity may be felt more strongly in the areas immediately adjacent the vibration motors 236, 238. Thus, for example, the vibration motor 236 may cause a stronger vibration on the side of the handle 232 that the vibration motor 236 is coupled to, while the vibration motor 238, which is centered in the inner cavity 234, may cause all sides of the handle 232 to vibrate at an equal intensity. FIGS. 14 and 15 illustrate a prototype of a joystick 244 according to another example embodiment. The joystick 244 may be a boom control joystick, similar to the second joystick 204, and includes a handle 245. A vibration motor 246 is mounted to an upper surface 248 of an inner cavity 250 of the handle 245.

As discussed above, in some embodiments, audible alerts may be generated (e.g., by a speaker). Much like the vibration of the vibration motors 214, 216, sounds may be generated more frequently or more loudly when an object is close to the telehandler 10 or when the object is determined to be a human. The pitch, tone, pattern, or content (e.g., in the case of a verbal alert) of the alert may also be adjusted.

### Visual Feedback System

In some embodiments, alerts may be provided to an operator of a lift vehicle visually. The following examples make reference to a boom lift 310, but it should be understood that similar systems and methods may apply to other types of lift devices (e.g., telehandlers, scissor lifts, etc.

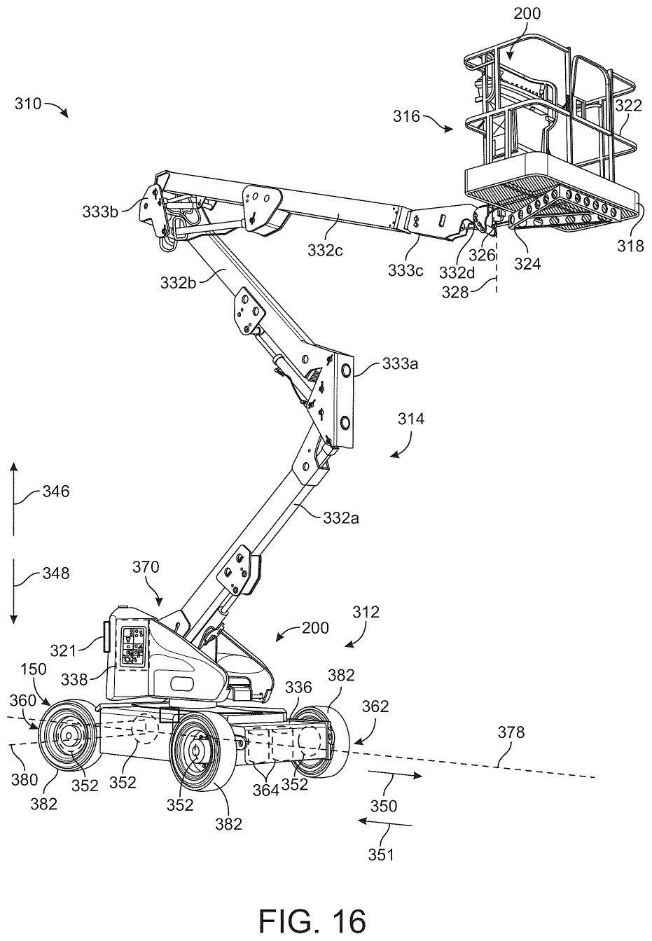

Referring to FIG. 16, a lift vehicle, shown as a boom lift 310, includes a base assembly 312 (e.g., a support assembly, a drivable support assembly, a support structure, etc.), a platform assembly 316 (e.g., a platform, a terrace, etc.), and a lift assembly 314 (e.g., a boom lift assembly, a lifting apparatus, an articulated arm, a scissors lift, etc.). If the lift device is a telehandler, platform assembly 316 can be replaced with a fork apparatus, a bucket apparatus, a material lifting apparatus, a mechanical lifting apparatus attachment, an implement, etc. The boom lift 310 includes a front end (e.g., a forward facing end, a front portion, a front, etc.), shown as front 362, and a rear end (e.g., a rearward facing end, a back portion, a back, a rear, etc. ,) shown as rear 360. The lift assembly 314 is configured to elevate the platform assembly 316 in an upwards direction 346 relative to base assembly 312. The lift assembly 314 is also configured to translate the platform assembly 316 in a downwards direction 348. The lift assembly 314 is also configured to translate the platform assembly 316 in either a forward direction 350 or a rearward direction 351. The lift assembly 314 generally facilitates performing a lifting function to raise and lower the platform assembly 316, as well as movement of the platform assembly 316 in various directions to access elevated locations.

The base assembly 312 defines a longitudinal axis 378 and a lateral axis 380. The longitudinal axis 378 defines the forward direction 350 of lift device 310 and the rearward direction 351. The boom lift 310 is configured to translate in the forward direction 350 and to translate backwards in rearward direction 351. The base assembly 312 includes one or more wheels, tires, wheel assemblies, tractive elements, rotary elements, treads, etc., shown as tractive elements 382. The tractive elements 382 are configured to rotate to drive (e.g., translate, steer, move, etc.) the boom lift 310. The tractive elements 382 can each include an electric motor 352 (e.g., electric wheel motors) configured to drive the tractive elements 382 (e.g., to rotate the tractive elements 82 to facilitation motion of boom lift 310). In other embodiments, the tractive elements 382 are configured to receive power (e.g., rotational mechanical energy) from the electric motors 352 through a drive train (e.g., a combination of any number and configuration of a shaft, an axle, a gear reduction, a gear train, etc.). The tractive elements 382 and electric motors 352 can facilitate a driving and/or steering function of the boom lift 310.

The platform assembly 316 is configured to provide a work area for an operator of the boom lift 310 to stand/rest upon. The platform assembly 316 can be pivotably coupled to an upper end of the lift assembly 314. The boom lift 310 is configured to facilitate the operator accessing various elevated areas (e.g., lights, platforms, the sides of buildings, building scaffolding, trees, power lines, etc.). The boom lift 310 uses various electrically powered motors and electrically powered linear actuators to facilitate elevation of the platform assembly 316 (e.g., relative to the base assembly 312, or to a ground surface that the base assembly 312 rests upon). The platform assembly 316 includes a base member, a base portion, a platform, a standing surface, a shelf, a work platform, a floor, a deck, etc., shown as a deck 318. The deck 318 provides a space (e.g., a floor surface) for a worker to stand upon as platform assembly 316 is raised and lowered.

The platform assembly 316 includes various members, beams, bars, guard rails, rails, railings, etc., shown as rails 322. The rails 322 extend along substantially an entire perimeter of deck 18. The rails 322 provide one or more members for the operator of the boom lift 310 to grasp while using the boom lift 310 (e.g., to grasp while operating the boom lift 310 to elevate the platform assembly 316). The rails 322 can include members that are substantially horizontal to the deck 318. The rails 322 can also include vertical structural members that couple with the substantially horizontal members. The vertical structural members can extend upwards from the deck 318.

The platform assembly 316 can include a user interface panel 200, which may be similar user interface panel 200 of FIG. 9. The user interface panel 200 is configured to receive user inputs from the operator at the platform assembly 316 to facilitate operation of the boom lift 310. The user interface panel 200 can include any number of buttons, levers, switches, keys, joysticks, steering wheels etc., or any other user interface device 104 configured to receive a user input to operate the boom lift 310. The user interface panel 200 can be supported by one or more of the rails 322.

The platform assembly 316 includes a frame 324 (e.g., structural members, support beams, a body, a structure, etc.) that extends at least partially below the deck 318. The frame 324 can be integrally formed with the deck 318. The frame 324 is configured to provide structural support for deck 18 of platform assembly 16. The frame 324 can include any number of structural members (e.g., beams, bars, I-beams, etc.) to support deck 18. The frame 324 couples the platform assembly 316 with the lift assembly 314. The frame 324 may rotatably or pivotably coupled with the lift assembly 314 to facilitate rotation of the platform assembly 316 about an axis 328 (e.g., a centerline). The frame 324 can also be rotatably/pivotably coupled with the lift assembly 314 such that the frame 324 and the platform assembly 316 can pivot about an axis 325 (e.g., a centerline).

The platform assembly 316 is configured to be driven to pivot about axis 328 (e.g., rotate about axis 328 in either a clockwise or a counter-clockwise direction) by an electric motor 326 (e.g., a rotary electric actuator, a stepper motor, a platform rotator, a platform electric motor, an electric platform rotator motor, etc.). The electric motor 326 can be configured to drive the frame 324 to pivot about axis 328 relative to the upper lift arm 332c (or relative to the intermediate lift arm 332d). The electric motor 326 can be configured to drive a gear train to pivot the platform assembly 316 about axis 328.

As shown, the base assembly 312 includes one or more energy storage devices (e.g., capacitors, batteries, Lithium-Ion batteries, Nickel Cadmium batteries, etc.), shown as batteries 364. The batteries 364 are configured to store energy in a form (e.g., in the form of chemical energy) that can be converted into electrical energy for the various electric motors and electric actuators of the boom lift 310. The batteries 364 can be stored within the base 336. The boom lift 310 includes a controller 338 (e.g., similar to the controller 102) configured to operate any of the electric motors, electric actuators, etc., of the boom lift 310. The controller 338 can be configured to receive sensory input information from various sensors of the boom lift 310 (e.g., the camera 42, the distance sensor 44, etc.) user inputs from the user interface panel 200 (or any other user input device such as a key-start or a push-button start), etc. The controller 338 can be configured to generate control signals for the various electric motors, electric actuators, etc., of the boom lift 310 to operate any of the electric motors, electric actuators, electrically powered movers, etc., of the boom lift 310.

The batteries 364 are configured to power any of the electrical motors, sensors, actuators, electric linear actuators, electrical devices, electrical movers, stepper motors, etc., of the boom lift 310. The base assembly 312 can include a power circuit including any necessary transformers, resistors, transistors, thermistors, capacitors, etc., to provide appropriate power (e.g., electrical energy with appropriate current and/or appropriate voltage) to any of the electric motors, electric actuators, sensors, electrical devices, etc., of the boom lift 310. The batteries 364 are configured to deliver power to electric motors 352 to drive the tractive elements 382. A rear set of tractive elements 382 can be configured to pivot to steer the boom lift 310. In other embodiments, a front set of tractive elements 382 are configured to pivot to steer the boom lift 310. In still other embodiments, both the front and the rear sets of tractive elements 82 are configured to pivot (e.g., independently) to steer the boom lift 310.

The base assembly 312 can include one or more laterally extending frame members (e.g., laterally extending structural members) and one or more longitudinally extending frame members (e.g., longitudinally extending structural members). The base assembly 312 includes a steering system 150. Steering system 150 is configured to drive the tractive elements 382 to pivot for a turn of the boom lift 310. The steering system 150 can be configured to pivot the tractive elements 382 in pairs (e.g., to pivot a front pair of tractive elements 382) or can be configured to pivot the tractive elements 382 independently (e.g., four-wheel steering for tight-turns). The base assembly 12 can include a second user interface panel 321, which may include for example, buttons, switches, a touchscreen, etc. In some embodiments, the second user interface panel 321 is coupled with base 36. In other embodiments, the second user interface panel 321 is positioned on the turntable 370. The second user interface panel 321 can be positioned on any side or surface of the base assembly 312 (e.g., on the front 362 of the base 336, on the rear 360 of the base 336, etc.).

While the embodiment shown in FIG. 16 is an all-electric boom lift 310, it should be understood that the aspects of the boom lift 310 described herein may also apply to a boom lift 310 powered by an engine (e.g., an internal combustion engine).

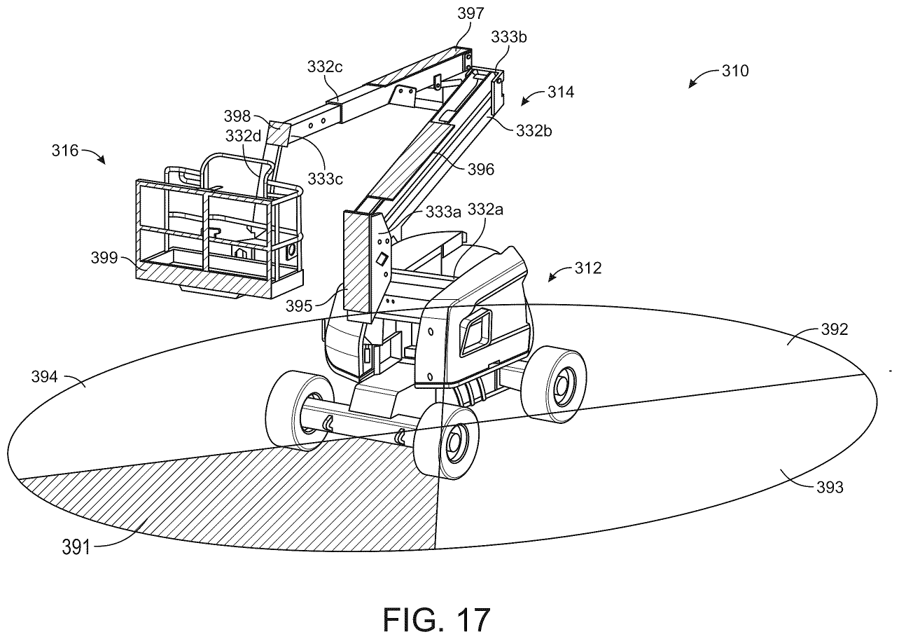

Referring now to FIGS. 17-19, the boom lift 310 is shown with nine sensor zones 391-399 (regions, areas, etc.), according to an example embodiment. The boom lift 310 may include one or more sensors (e.g., cameras 42, distance sensors 44) arranged to detect objects in each sensor zone 391-399. The sensors associated with the first sensor zone 391 may be arranged to detect objects on or near the ground forward of the front 362 of the boom lift 310. The sensors associated with the second sensor zone 392 may be arranged to detect objects on or near the ground rearward of the rear 360 of the boom lift 310. The sensors associated with the third sensor zone 393 may be arranged to detect objects on or near the ground to the left of the boom lift 310. The sensors associated with the fourth sensor zone 394 may be arranged to detect objects on or near the ground to the right of the boom lift 310. The sensors associated with the fifth sensor zone 395 may be arranged to detect objects outward of the lower pivot member 333a. The sensors associated with the sixth sensor zone 396 may be arranged to detect objects above the intermediate lift arm 332b near the connection to the lower pivot member 333a. The sensors associated with the seventh sensor zone 397 may be arranged to detect objects above the upper lift arm 332c near the connection to the intermediate pivot member 333b. The sensors associated with the eighth sensor zone 398 may be arranged to detect objects above the upper lift arm 332c near the connection to the upper pivot member 333c. The sensors associated with the ninth sensor zone 399 may be arranged to detect objects outward of the platform assembly 316.

Taken together, the sensors and cameras associated with all the sensor zones 391-399 may cover all of the areas into which the envelope of the boom lift 310 may expand, providing 360-degree detection of objects proximate the boom lift 310. For example, the tractive elements 382 of the boom lift 310 may cause the boom lift 310 to move toward sensor zones 391-395 and 399. Lowering the lower lift arm 332a may cause the lower pivot member 333a to move toward the fifth sensor zone 395 and the platform assembly 316 to move toward the ninth sensor zone 399. Raising the lower lift arm 332a may cause intermediate lift arm 332b to move toward the sixth sensor zone 396 and the upper lift arm 332c to move toward the seventh sensor zone 397 and the eighth sensor zone 398. In some embodiments, the boom lift 310 may have additional sensor zones, such as a sensor zone below the platform assembly 316 with sensors configured to detect objects underneath the platform assembly 316. It should be understood that, because sensor zones may move when components of the scissor lift 410 move, “moving toward a sensor zone” refers to moving toward the area encompassed by the sensor zone before the movement.

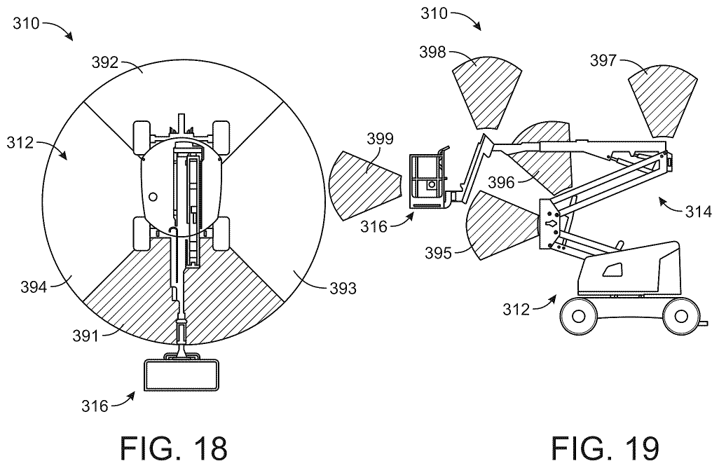

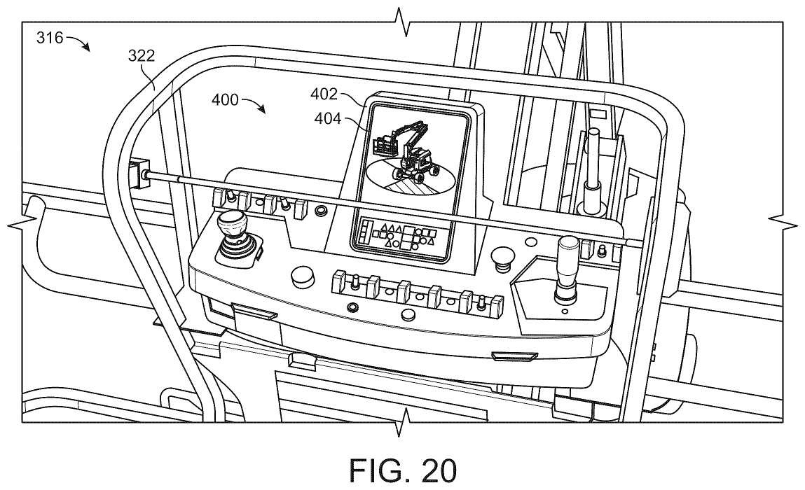

Referring now to FIG. 20, a user interface panel 400 is shown mounted to the rails 322 of the platform assembly 316, according to an example embodiment. The user interface panel 400 may be substantially similar to the user interface panel 200 but may include a display screen 402. In some embodiments, the display screen 402 may be a touchscreen configured to receive operator input. The display screen 402 may be configured to display a graphical user interface (GUI) 404. The display screen 402 may be communicatively coupled to the controller 338, which may generate the GUI 404 and cause the display screen 402 to display the GUI 404. The GUI 404 may provide information (e.g., alerts, notifications, etc.) to the operator on the platform assembly 316 regarding objects detected by the sensors associated with each sensor zone 391-399. The GUI 404 may show one or more of the views of FIGS. 17-19, specifically a perspective view, a top view, and/or a side view of the boom lift 310 with graphical representations of the sensor zones 391-399. In some embodiments, the controller 338 may update the GUI 404 such that the graphical representations of the sensor zone 391-399 appear “empty” when no object is detected in the sensor zone 391-399 and may appear “filled” when an object is detected in the sensor zone 391-399. For example, as shown in FIG. 18, the graphical representation of the first sensor zone 391 is filled and the graphical representations of the second, third, and fourth sensor zones 392-394 are empty. This may indicate that an object is detected in the first sensor zone 391 and that no objects are detected in the second, third, or fourth sensor zones 392-394. The graphical representations of the upper sensor zones 395-399 may appear as shown in FIG. 19, highlighting the area in which an object may be detected, or may appear as shown in FIG. 17, highlighting the components of the boom lift 310 adjacent the sensor zones 395-399 (e.g., the components closest to the detected object).

As discussed above, the GUI 404 may be provided by the controller 338 to the display screen 402 and observed by an operator on the platform assembly 316, who may be operating the boom lift 310 using the control panel 400. In some embodiments, the controller 338 may update the GUI 404 such that the color of a filled graphical representation of a sensor zone 391-399 corresponds to the proximity of the detected object to the boom lift 310. For example, as discussed above with respect to FIG. 8, each sensor zone 391-399 may include a green zone relatively far from the boom lift 310 (e.g., similar to green zone 122), a yellow zone an intermediate distance from the boom lift 310 (e.g., similar to yellow zone 124), and a red zone immediately adjacent the boom lift 310 (e.g., similar to red zone 126). These zones may correspond to the color indicated on the GUI. For example, if an object is detected in the green zone of the first sensor zone 391, the graphical representation of the first sensor zone 391 in the GUI 404 may appear as a filled green shape; if an object is detected in the yellow zone of the fourth sensor zone 394, the graphical representation of the fourth sensor zone 394 may appear in the GUI 404 as a filled yellow shape, etc. The controller 338 may be configured to continuously or periodically (e.g., several times per second) update the GUI 404 to indicate detected objects in real-time or near real-time. In some embodiments, the GUI 404 may be different depending on the type of object detected. For example, is a pedestrian is detected, the graphical representation of the respective sensor zone 391-399 may flash on and off in addition to changing colors based on distance.

In some embodiments, the GUI 404 may include the video feed from the camera 42. If the controller 338 determines based on the image data from the camera (e.g., using image processing techniques, deep neural processing, tensor processing, machine learning, etc.) that a detected object is a human (e.g., a pedestrian), a bounding box may be overlaid on the video feed on the GUI 404 surrounding and following the image of the human. In some embodiments, an icon may be overlaid on the GUI 404 that follows the image of the human (e.g., instead of or in addition to the bounding box). The bounding box and/or the icon may be shown in a color corresponding to the distance to the human from the distance sensor 44 (e.g., green, yellow, and red as discussed above with respect to the graphical representation of the sensor zones 391-399). The bounding box and/or the icon may flash, change in shape or size, or otherwise change based on the distance to the human from the distance sensor 44. In embodiments with multiple cameras 42, the GUI 404 may include tiled views of video feed from each camera. Bounding boxes and/or icons may be overlaid on any of the video feeds when a pedestrian is detected, as discussed above. In some embodiments, the controller 338 may be configured to track the movement of an object and predict a future location of the object. For example, the controller 338 may predict that an object moving at a constant speed will continue to move at this speed for at least a predetermined amount of time. If the telehandler 10 is expected to intersect with the future location of the object, a higher level of alert may be generated than would be indicated by the current location of the object. For example, the alert may correspond to a red zone 126 alert even if the distance to the object would trigger a green zone 122 alert if the object were stationary. Similarly, the vibration pattern in a user interface device 104 with a haptic feedback system may be defined or adjusted based on the predicted future location.

In some embodiments, the controller 338 may be configured to display the video feed from the rear-facing camera 42 only when the telehandler 10 is in the reverse gear. In some embodiments, the controller 338 may be configured to continue displaying the video feed from the rear-facing camera 42 for a predetermined amount of time (e.g., 3 seconds, 5 seconds, 10 seconds, etc.) after the telehandler 10 has been taken out of the reverse gear. In some embodiments, the controller 338 may be configured to display the video feeds from one or more cameras as soon as the ignition is started on the telehandler 10. In some embodiments, any of these features may be disabled by the operator. In some embodiments, the controller 338 may be configured to display the video feed from any of one or more cameras only when an object is detected in the field of view of the camera 42.

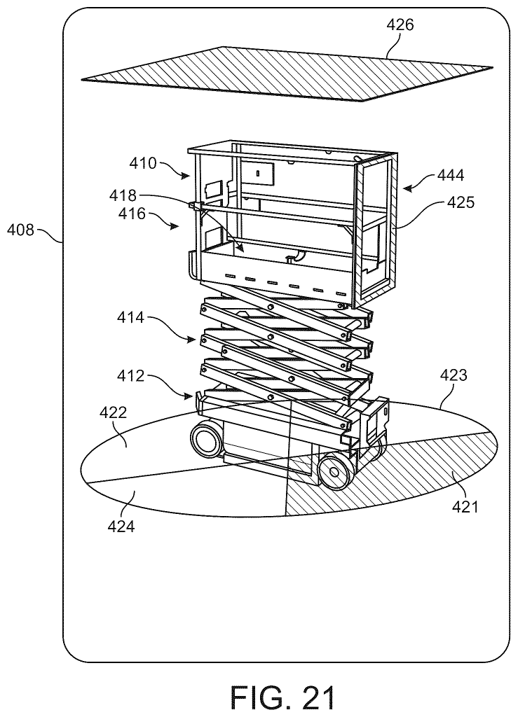

Similar GUIs may be used in different lift vehicles (e.g., scissor lifts, telehandlers, etc.). Consistency across lift vehicles may help operators understand the information and alerts provided by the GUI, so that operators can respond appropriately to detected objects regardless of the type of lift vehicle. FIG. 21 shows a GUI 408 that may be displayed on a display screen of a scissor lift 410, and FIG. 22 shows a GUI 470 that may be displayed on a display screen of a telehandler 10. The GUI 408 illustrates the scissor lift 410 with graphical representations of six sensor zones 421-426. The scissor lift 410 includes a includes a base assembly 412 (e.g., a support assembly, a drivable support assembly, a support structure, etc.), a platform assembly 416 (e.g., a platform, a terrace, etc.), and a lift assembly 414 (e.g., a scissors lift, etc.). The lift assembly 414 is configured to elevate the platform assembly 416 in an upwards direction relative to base assembly 412. The lift assembly 414 is also configured to translate the platform assembly 416 in a downwards direction.

The scissor lift 410 is configured to translate in a forward direction and a rearward direction. The base assembly 412 includes one or more wheels, tires, wheel assemblies, tractive elements, rotary elements, treads, etc., shown as tractive elements 482. The tractive elements 482 are configured to rotate to drive (e.g., translate, steer, move, etc.) the scissor lift 410.

The platform assembly 416 is configured to provide a work area for an operator of the scissor lift 410 to stand/rest upon. The platform assembly 416 can be pivotably coupled to an upper end of the lift assembly 414. The scissor lift 410 is configured to facilitate the operator accessing various elevated areas (e.g., lights, platforms, the sides of buildings, building scaffolding, trees, power lines, etc.). The platform assembly 416 includes a base member, a base portion, a platform, a standing surface, a shelf, a work platform, a floor, a deck, etc., shown as a deck 418. The deck 418 provides a space (e.g., a floor surface) for a worker to stand upon as platform assembly 416 is raised and lowered. The platform assembly 416 may have a cantilever portion 444 that may be selectively laterally extended from the platform assembly 416 to expand the size of the deck 418 and allow access to areas above objects. For example, the scissor lift 410 may be positioned adjacent to an object, the lift assembly 414 may raise the platform assembly 416 above the object, and the cantilever portion 444 may be extended over the object, cantilevered from the rest of the platform assembly 416, such that the operator may reach areas above the object.

The platform assembly 416 can include a user interface panel (not shown), which may be similar to the user interface panel 400 of FIG. 20. As discussed above, the GUI 408 illustrates the scissor lift 410 with graphical representations of six sensor zones 421-426. The GUI 408 may be displayed, for example, on the display screen 402 of the user interface panel 400. The scissor lift 410 may include one or more sensors (e.g., cameras 42, distance sensors 44) arranged to detect objects in each sensor zone 421-426. The sensors associated with the first sensor zone 421 may be arranged to detect objects on or near the ground forward of the front of the scissor lift 410. The sensors associated with the second sensor zone 422 may be arranged to detect objects on or near the ground rearward of the rear of the scissor lift 410. The sensors associated with the third sensor zone 423 may be arranged to detect objects on or near the ground to the left of the scissor lift 410. The sensors associated with the fourth sensor zone 424 may be arranged to detect objects on or near the ground to the right of the scissor lift 410. The sensors associated with the fifth sensor zone 425 may be arranged to detect objects forward of the cantilever portion 444. The sensors associated with the sixth sensor zone 426 may be arranged to detect objects above the platform assembly 416.

Taken together, the sensors associated with all the sensor zones 421-426 may cover all of the areas into which the envelope of the scissor lift 410 may expand. For example, the tractive elements 482 of the scissor lift 410 may cause the scissor lift 410 to move toward sensor zones 421-424. Extending the cantilever portion 444 may cause the cantilever portion 444 to move toward the fifth sensor zone 395. Raising the platform assembly 416 may cause the platform assembly 416 to move toward the sixth sensor zone 426.

FIG. 22 shows a GUI 470 illustrating a telehandler 10 with graphical representations of six sensor zones 471-474. The GUI 470 may be displayed, for example, on the display screen 402 of the user interface panel 400, which may be incorporated into the telehandler (e.g., instead of the user interface panel 200). The telehandler 10 may include one or more sensors (e.g., cameras 42, distance sensors 44) arranged to detect objects in each sensor zone 471-474. The sensors associated with the first sensor zone 471 may be arranged to detect objects on or near the ground forward of the front of the telehandler 10. The sensors associated with the second sensor zone 472 may be arranged to detect objects on or near the ground rearward of the rear of the telehandler 10. The sensors associated with the third sensor zone 423 may be arranged to detect objects on or near the ground to the left of the telehandler 10. The sensors associated with the fourth sensor zone 424 may be arranged to detect objects on or near the ground to the right of the telehandler 10. The telehandler 10 may include additional sensor zones, for example, to cover areas into which the boom 30 may move.

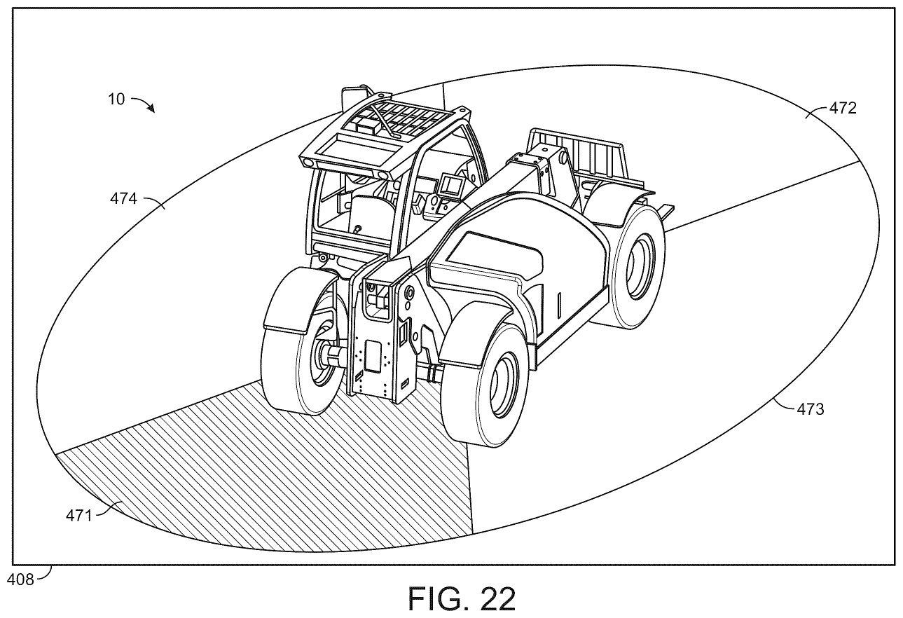

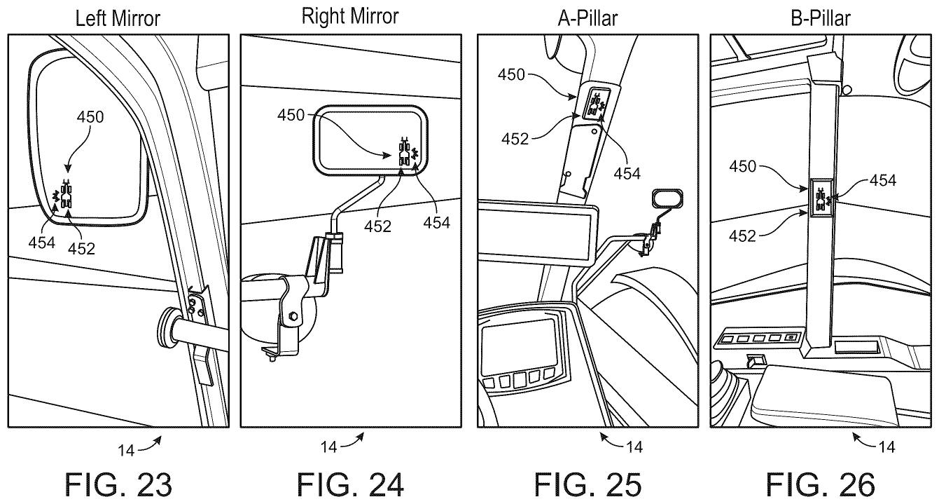

Referring now to FIGS. 23-26, various portions of the operator cab 14 of the telehandler 10 are shown, according to example embodiments. In each of FIGS. 23-26, an indicator 450 is positioned on a portion of the operator cab 14 to provide alerts to the operator when an object is detected proximate the telehandler 10. The indicator 450 may light up to provide the alert. The indicator may have a shape that conveys to the operator that an object has been detected. For example, the shape of the indicators 450 in FIGS. 23-26 appears as a telehandler 452 with a symbol 454 suggesting a possible collision with the side of the telehandler 452. The position of the symbol 454 may indicate the direction of the detected object. For example, FIG. 23 shows a left side mirror 456, which may be positioned roughly in front of the operator on the left side of the operator cab 14, with the indicator 450 showing the symbol 454 on the left side of the telehandler 452. This may suggest that an object has been detected on the left side of the telehandler 10. FIG. 24 shows a right side mirror 458, which may be positioned roughly in front of the operator on the right side of the operator cab 14, with the indicator showing the symbol 454 on the right side of the telehandler 452. This may suggest that an object has been detected on the right side of the telehandler 10. FIG. 25 shows a right side A-pillar 460, which may be positioned roughly in front of the operator on the right side of the operator cab 14, with the indicator showing the symbol 454 on the right side of the telehandler 452. This may suggest that an object has been detected on the right side of the telehandler 10. FIG. 26 shows a right side B-pillar 462, which may be positioned to the right of the operator on the right side of the operator cab 14 with the indicator showing the symbol 454 on the right side of the telehandler 452. This may suggest that an object has been detected on the right side of the telehandler 10. In some embodiments, the indicator 450 may appear on a GUI or a dead front panel instead of or in addition to the freestanding indicators shown in FIGS. 23-26. The indicator 450 may be illuminated in at least an area that the operator is expected to be looking. For example, if the telehandler is turning to the right or reversing, the indicator on the right side mirror 458 may be illuminated because it is expected that the operator would check the right side mirror 458 upon turning right or reversing.

In other embodiments, the symbol 454 may be positioned in front of or behind the telehandler 452, indicating that an object has been detected in front of or behind the telehandler 10, respectively. In some embodiments, the indicator 450 may change colors, blink, or flash depending, for example on the distance of the object to the telehandler or the type of object detected (e.g., animate or inanimate). For example, the indicator may blink faster when an object is closer. In some embodiments, there may be multiple indicators 450. The number of indicators that are illuminated or otherwise activated may correspond to the proximity of the detected object. For example; one indicator 450 may be illuminated when an object is detected relatively far from the telehandler 10 (e.g., in the green zone 122); two indicators 450 may be illuminated when an object is detected an intermediate distance from the telehandler 10 (e.g., in the yellow zone 124); and three indicators 450 may be illuminated when an object is detected relatively close to the telehandler 10 (e.g., in the red zone 126).

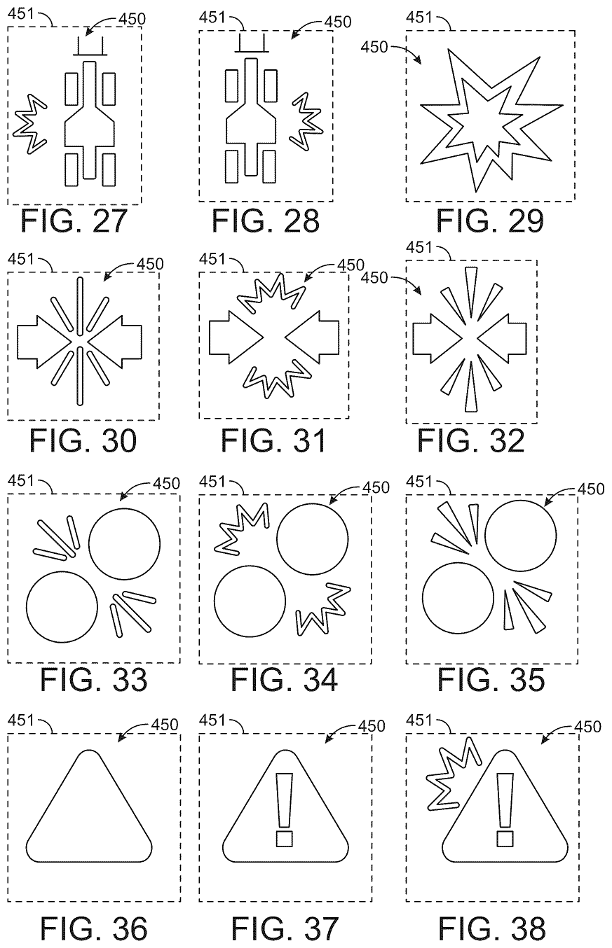

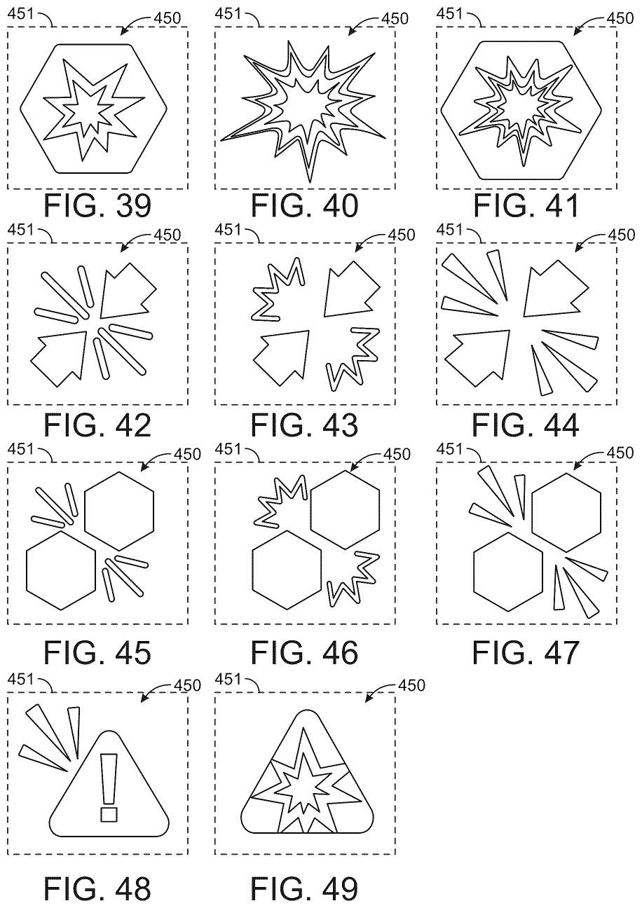

FIGS. 27-49 show GUIs 451 with indicators 450 according to various designs. For example, FIGS. 27 and 28 show the indicator 450 shown in FIGS. 23-26. FIGS. 29-49 show alternative designs that may be used in place of the indicator 450 shown in FIGS. 23-26. While shown on a GUI 451, it should be understood that these designs may be used as freestanding indicators as shown in FIGS. 23-26, for example, on a mirror 456, 258 or a pillar 460, 462 of the operator cab 14. These indicators 450 may also be shown on a dead front panel.

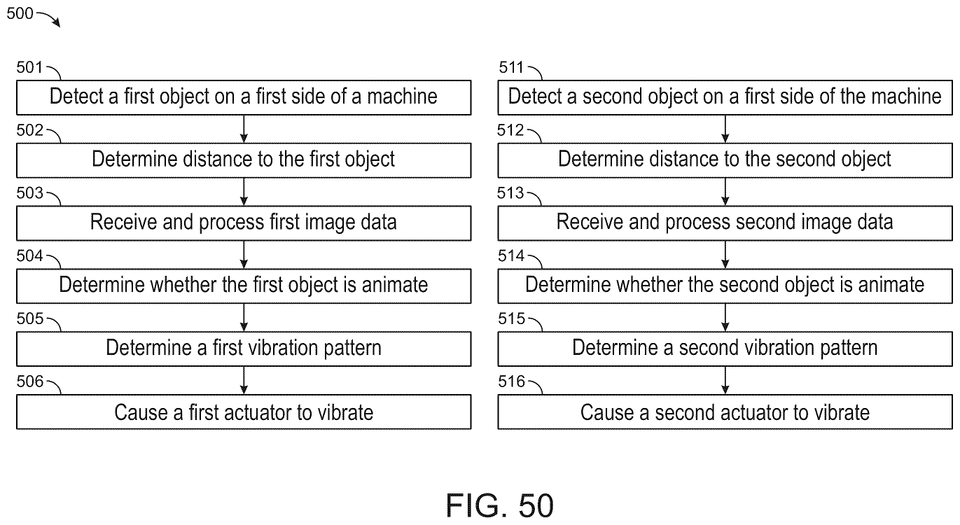

Referring now to FIG. 50, a method 500 for controlling a user interface device (e.g., joystick 202) having two actuators (e.g., vibration motors 214, 216, piezoelectric actuators, electromagnetic actuators) is shown. The method 500 may be performed, for example, by a controller or control unit (e.g., controller 102, controller 338, a vehicle control unit, etc.) At operation 501 of the method 500, a first object is detected on a first side of a machine (e.g., in a first zone, in front of the machine, behind the machine, adjacent a base assembly of the machine, adjacent a lift assembly of the machine, etc.). The first object may be detected by a distance sensor (e.g., distance sensor 44) and/or a camera (e.g., camera 42) arranged to monitor the first side of the machine.

At operation 502 of the method 500, a distance to the first object is determined. In some embodiments, distance may be determined based on sensor data from the sensor. In some embodiments, the distance may be determined based on image data from the camera. At operation 503 of the method 500, image data from the camera is received and processed. In some embodiments, the image data may be a video stream. The image data may be processed using an object detection and classification algorithm. The algorithm may use deep neural processing, tensor processing, and/or machine learning techniques. At operation 504 of the method 500, the processed image data is used to determine whether the first object is animate or inanimate. In some embodiments, the processed image data may be used to determine whether the first object is a human. In some embodiments, the processed image data may be used to determine whether the first object is a pedestrian.

At operation 505 of the method 500, a first vibration pattern is determined. The vibration pattern may include a pattern of vibration pulses (e.g., on and off cycles) and/or vibrations of varying intensity. The vibration pattern may be determined based at least in part on the distance determined in operation 502 and the determination in operation 504 of whether the first object is animate or inanimate. For example, the vibrations may be higher intensity vibrations when the first object is animate, and the pulses may be more frequent when the first object is closer to the machine. At operation 506 of the method 500, a first actuator is caused to vibrate according to the first vibration pattern.

Operations 511-516 may occur in parallel with operations 501-506. Operations 511-516 may be respectively substantially the same as operations 501-506, except that they relate to detecting objects on a second side of the machine (e.g., in a second zone, in front of the machine, behind the machine, adjacent a base assembly of the machine, adjacent a lift assembly of the machine, etc.). Thus, based on sensor data from a distance sensor arranged to monitor the second side of the machine and/or camera data from a camera arranged to monitor the second side of the machine, a vibration pattern is determined, and a second actuator is caused to vibrate.

Notably, the data from the distance sensor and camera arranged to monitor the first side of the machine are not used to control the second actuator, and the data from the distance sensor and camera arranged to monitor the second side of the machine are not used to control the first actuator. An operator may thus be alerted as to a location of a detected object based on which actuator vibrates. For example, the actuators may be positioned on the side of the user interface device (e.g., a joystick, a switch, a knob, etc.) that correspond to the zone in which the corresponding distance sensor and camera monitor. For example, if pushing a joystick left causes a boom of the machine to move left, data from the distance sensor and camera that monitor a zone to the left of the boom may be used to determine whether an actuator on the left side of the joystick vibrates. If pushing the joystick right causes a boom of the machine to move right, data from the distance sensor and camera that monitor a zone to the right of the boom may be used to determine whether an actuator on the right side of the joystick vibrates.

In some embodiments, the first actuator and the second actuator may be positioned in or coupled to different user interface devices and may vibrate when objects are detected on sides of the machine near devices controlled by the respective user interface device. For example, the first user interface device may control a base assembly of the machine (e.g., may control wheels of the machine) and the second user interface device may control a lift assembly (e.g., a boom) of the machine. The first actuator may be caused to vibrate when an object is detected adjacent the base assembly, and the second actuator may be caused to vibrate when an object is detected adjacent the lift assembly. Because operations 501-506 and operation 511-516 are executed in parallel, if objects are detected on both sides of the machine, both the first and second actuators may be caused to vibrate simultaneously. However, if an object is detected only on one side of the machine, only one of the first and second actuators may be caused to vibrate.

It should be understood that, in some embodiments, the method 500 may include additional operations not shown. For example, the method 500 may include using the processed image data to predict a future location of an animate object, and the vibration pattern may further be based on the predicted future location. In some embodiments, the method 500 may not include some of the operations shown. For example, in some embodiments, the machine may not include a camera, and the vibration pattern may be determined based only on data from the distance sensor. Thus, the method 500 may not include operations 503 and 504.

### Configuration of Exemplary Embodiments

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

1. A work machine comprising:
a first user interface device comprising a first vibration motor and a second vibration motor; and
an object detection system comprising a controller communicatively coupled to the first user interface device, the controller comprising at least one processor and at least one memory storing instructions that, when executed by the at least one processor, cause the at least one processor to perform operations comprising:
receiving a first indication that a first object has been detected on a first side of the work machine;
upon receiving the first indication, causing the first vibration motor to activate without causing the second vibration motor to activate;
receiving a second indication that a second object has been detected on a second side of the work machine; and
upon receiving the second indication, causing the second vibration motor to activate without causing the first vibration motor to activate.

2. The work machine of claim 1, wherein the object detection system further comprises:
a first sensor communicatively coupled to the controller and configured to detect objects on the first side of the work machine and to generate first sensor signals, the first indication comprising the first sensor signals; and
a second sensor communicatively coupled to the controller and configured to detect objects on the second side of the work machine and to generate second sensor signals, the second indication comprising the second sensor signals.

3. The work machine of claim 2, further comprising a camera comprising a neural processing unit configured to:
detect the first object;
determine whether the object is a pedestrian; and
determine a first estimated distance from the first object to the work machine;
wherein the operations further comprise:
determining, based on the first sensor signals, a second estimated distance from the first object to the work machine;
compare the first estimated distance to the second estimated distance to determine a closer estimated distance; and
based on the closer estimated distance and whether the object is a pedestrian, adjusting an activation pattern of the first vibration motor.

4. The work machine of claim 3, further comprising a camera communicatively coupled to the controller and configured to generate image data, the camera positioned immediately above or immediately below the first sensor and having a field of view that overlaps a field of view of the first sensor, the operations further comprising processing the image data using an object detection and classification algorithm to determine whether the first object is human.

5. The work machine of claim 2, wherein the operations further comprise:
determining, based on the first sensor signals, a distance from the first object to the first sensor; and
based on the determined distance, adjusting a vibration intensity of the first vibration motor.

6. The work machine of claim 1, wherein the object detection system further comprises a camera communicatively coupled to the controller and configured to generate image data, the operations further comprising:
determining, based on the image data, that the first object is a human; and
based on determining that the first object is a human, adjusting an activation pattern of the first vibration motor.

7. The work machine of claim 1, wherein the object detection system further comprises a camera communicatively coupled to the controller and configured to generate image data, the operations further comprising:
determining, based on the image data, that the first object is a human; and
based on determining that the first object is a human, adjusting a vibration intensity of the first vibration motor.

8. The work machine of claim 1, wherein the object detection system further comprises a camera communicatively coupled to the controller and configured to generate image data, the operations further comprising:
tracking, based on the image data, movement of the first object;
predicting, based on the tracked movement, a future location of the first object; and
adjusting an activation pattern of the first vibration motor based on the predicted future location.

9. The work machine of claim 1, wherein the first user interface device comprises a joystick comprising one or more restrainer motors configured to selectively restrain deflection of the joystick in a first direction, the operations further comprising:
receiving a third indication that the joystick has been deflected in the first direction;
upon receiving the third indication that the joystick has been deflected in the first direction and determining that no objects have been detected on the first side of the work machine, causing the work machine to move in the first direction; and
based on receiving the first indication that the first object has been detected the first side of the work machine, activating at least one of the one or more restrainer motors to restrain deflection of the joystick in the first direction.

10. The work machine of claim 1, wherein the first vibration motor is positioned on a first side of the first user interface device corresponding to the first side of the work machine, and the second vibration motor is positioned on a second side of the first user interface device corresponding to the second side of the work machine.

11. The work machine of claim 1, further comprising a second user interface device communicatively coupled to the controller and comprising a third vibration motor, the operations further comprising:
receiving a third indication that a third object has been detected on the first side of the work machine; and
based on receiving the third indication, causing the third vibration motor to activate without causing the first vibration motor or the second vibration motor to activate.

12. A vehicle comprising:
a base assembly comprising tractive elements;
a lift assembly coupled to the base assembly and configured to lift an implement;
a base sensor configured to detect objects proximate the base assembly;
a lift sensor configured to detect objects proximate the lift assembly;
a first user interface device configured to control the tractive elements to move the vehicle, the first user interface device comprising a first vibration motor;
a second user interface device configured to control the lift assembly to selectively raise and lower the implement, the second user interface device comprising a second vibration motor; and
a controller configured to:
in response to receiving an indication that the base sensor has detected a first object, cause the first vibration motor to vibrate and not cause the second vibration motor to vibrate; and
in response to receiving an indication that the lift sensor has detected a second object, cause the second vibration motor to vibrate and not cause the first vibration motor to vibrate.

13. The vehicle of claim 12, wherein the controller is further configured to:
determine, based on data from the base sensor, a first distance from the base sensor to the first object; and
control a first vibration pattern of the first vibration motor based on the determined first distance.

14. The vehicle of claim 13, wherein the controller is further configured to:
determine, based on data from the lift sensor, a second distance from the lift sensor to the second object; and
control a second vibration pattern of the second vibration motor based on the determined second distance, wherein the second vibration pattern is the same as the first vibration pattern when the first distance and the second distance are equal.

15. The vehicle of claim 12, further comprising a third user interface device comprising a third vibration motor, the third user interface device configured to control a portion of the lift assembly, wherein in response to receiving the indication that the lift sensor has detected the second object, the controller is configured to cause both the second vibration motor and the third vibration motor to vibrate and not cause the first vibration motor to vibrate.

16. The vehicle of claim 12, wherein the controller is further configured to send a signal to an accessory device comprising an accessory device vibration motor in response to receiving the indication that the base sensor has detected the first object, the signal instructing the accessory device vibration motor to vibrate, the accessory device comprising one of a safety helmet, a glove, a safety harness, or a wearable smart device.

17. The vehicle of claim 16, wherein the controller instructs the accessory device vibration motor to vibrate and causes the first vibration motor to vibrate according to an identical pattern of pulses.

18. A vehicle comprising:
a joystick comprising a first side and a second side;
a first actuator coupled to the first side of the joystick;
a second actuator coupled to the second side of the joystick; and
a controller communicatively coupled to the joystick, the controller comprising at least one processor and at least one memory storing instruction that, when executed by the at least one processor, cause the at least one processor to perform operations comprising:
upon receiving a signal that the joystick is pivoted toward the first side, causing a component of the vehicle to move toward a first zone;
upon receiving a signal that the joystick is pivoted toward the second side, causing a component of the vehicle to move toward a second zone;
upon detecting an object in the first zone within a predetermined distance, causing the first actuator to vibrate, the second actuator not caused to vibrate based on objects detected in the first zone; and
upon detecting an object in the second zone within a predetermined distance, causing the second actuator to vibrate, the first actuator not caused to vibrate based on objects detected in the second zone.

19. The vehicle of claim 18, the operations further comprising:
determining a distance from the vehicle to the object in the first zone; and
comparing the distance to a threshold distance, wherein:
if the distance is larger than the threshold distance, the first actuator is caused to vibrate at a first intensity; and
if the distance is smaller than the threshold distance, the first actuator is caused to vibrate at a second intensity greater than the first intensity.

20. The vehicle of claim 18, the operations further comprising:
receiving a video stream corresponding to the first zone;
processing the video stream using an object detection and classification algorithm; and
determining, based on the processed video stream, whether the object in the first zone is an animate object or an inanimate object, wherein:
if the object in the first zone is determined to be inanimate, the first actuator is caused to vibrate at a first intensity; and
if the object in the first zone is determined to be animate, the first actuator is caused to vibrate at a second intensity greater than the first intensity.
